(19) United States
(12) Patent Application Publication
(10) Pub. No.: US 2010/0288835 A1
(43) Pub. Date: Nov. 18, 2010

(54) System for Giving and Organizing Gift Cards and Associated Method

(76) Inventor: Wendy Krepak, Winter Springs, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/810,216

(22) PCT Filed: Jan. 12, 2009
(86) PCT No.: PCT/US09/30773

§ 371 Date: Aug. 2, 2010

Related U.S. Application Data
(60) Provisional application No. 61/020,476, filed on Jan. 11, 2008.

(51) Int. Cl. G06K 5/00; B65D 85/00; B65B 5/04

(52) U.S. Cl. 235/380; 206/307; 53/473

(57) ABSTRACT

A gift coordinator includes a server accessible by at least one gift giver, the server including a merchant database of merchants for supplying gift cards, the merchant database being cross-indexed with gift recipient characteristics and gift occasions, the server adapted to recommend merchants for supplying gift cards. The card organizer includes an expandable pouch with a plurality of dividers arranged therein. The dividers have gift card indexing indicia thereon. A method for organizing gift cards includes arranging a plurality of dividers within an expandable pouch, the plurality of dividers having indexing indicia for the plurality of gift cards thereon, selecting a plurality of gift cards for insertion into the expandable pouch, sorting the plurality of gift cards based on the indexing indicia, and inserting the plurality of gift cards into the expandable pouch such that the plurality of gift cards correspond with the plurality of dividers having associated indexing indicia.

### CROSS-REFERENCE TO RELATED APPLICATION

The application claims the benefit of U.S. Provisional Application Ser. No. 61/020,476, filed on Jan. 11, 2008, the contents of which are hereby incorporated by reference in their entirety.

### FIELD OF THE INVENTION

The present invention relates to a system and associated method for giving and organizing gift cards.

### BACKGROUND OF THE INVENTION

A commonly-encountered difficulty in gift shopping is deciding what gift would be most suitable for a particular recipient. This difficulty is particularly apparent where gift selection involves questions of personal taste. For example, in the purchasing of clothing, home decor items, and the like, there is not only the difficulty of deciding what item to purchase, but also of selecting a particular style. Also, certain gifts, such as a meal at a favorite restaurant, do not lend themselves to being “given” in a traditional manner.

To generally facilitate the gift giving process and eliminate some of these difficulties, many merchants sell gift cards. Gift cards are purchased by the giver and typically allow the recipient to apply the purchase amount of the gift card to anything the merchant sells. Thus, the giver can be assured the recipient will get what he or she actually needs or prefers.

Despite the convenience of gift cards, the giving of gift cards is frequently criticized by consumer advocates for many reasons. For instance, gift cards, unlike cash, typically have an expiration date and if the entire purchase amount of the gift card is not used by the expiration date, the remainder of the gift card is lost to the recipient and results in windfall profits for the merchant. Similarly, unlike credit cards, most merchants will not issue replacement gift cards when a gift card is lost, again resulting in a loss to the recipient and a windfall for the merchant.

These losses most frequently occur because it can be difficult for a recipient to keep track of gift cards. For example, it may be difficult to locate a gift card in a large purse, and a recipient may prefer to make a purchase without the gift card to avoid causing a noticeable delay at the point of purchase. Similarly, a recipient may neglect to bring a particular gift card when shopping with the corresponding merchant. As it may be highly inconvenient to have to return to the merchant at a later time with the gift card, the recipient may again make the purchase without the gift card. Also, where a recipient has multiple gift cards, it can be easy to forget which merchants the recipient has gift cards for and inadvertently make a purchase without using a gift card. Additionally, it can be difficult to track the funds remaining on a partially used gift card, or distinguish used from new gift cards, further resulting in a failure to fully utilize gift cards.

For these and other reasons, many of these consumer advocate criticisms of gift cards are frequently justified, as all or a portion of the purchase amount of a gift card is not utilized by the recipient before the expiration date. For instance, there was an estimated 8 billion dollars in unused gift cards in 2006, alone. However, many gift givers are still reluctant to simply give cash. For instance, gift givers may perceive giving cash as too impersonal, or be concerned that selfless recipients will not use the cash to buy something fun for themselves.

### SUMMARY OF THE INVENTION

It is an object of the present invention to provide a system and associated method for giving and organizing gift cards that will simplify the acquisition and giving of gift cards and facilitate the complete utilization of the gift cards by the recipient. This and other objects, features, and advantages of the present invention will be better understood in light of the drawings and detailed description.

According to an embodiment of the present invention, a gift coordination system includes a gift coordinator adapted to facilitate the selection of gift cards and supply a card organizer to facilitate the arrangement of the gift cards. Advantageously, the gift coordinator includes a server accessible by at least one gift giver, the server including a merchant database of merchants for supplying gift cards, the merchant database being cross-indexed with gift recipient characteristics and gift occasions, the server adapted to recommend merchants for supplying gift cards based on at least one of the gift recipient characteristics and gift occasions. The card organizer includes an expandable pouch with a plurality of dividers arranged therein. The dividers have gift card indexing indicia thereon.

According to a method aspect of the present invention, a method for organizing gift cards includes arranging a plurality of dividers within an expandable pouch, the plurality of dividers having indexing indicia for the plurality of gift cards thereon, selecting a plurality of gift cards for insertion into the expandable pouch, sorting the plurality of gift cards based on the indexing indicia, and inserting the plurality of gift cards into the expandable pouch such that the plurality of gift cards correspond with the plurality of dividers having associated indexing indicia.

These and other objects, embodiments, aspects and advantages of the present invention will be appreciated in view of the drawings and detailed description of preferred embodiments.

### BRIEF DESCRIPTION OF THE DRAWINGS

FIG. 1 is a schematic view of a gift coordination system including a gift coordinator and a card organizer, according to an embodiment of the present invention;

FIG. 2 is a flow diagram of gift coordination operations of the gift coordinator of FIG. 1;

FIG. 3 is a schematic view of an occasion selection screen displayed by the gift coordinator during the operations of FIG. 2;

FIG. 4 is a schematic view of a recipient characteristic selection screen displayed by the gift coordinator during the operations of FIG. 2;

FIG. 5 is a schematic view of a merchant selection screen displayed by the gift coordinator during the operations of FIG. 2;

FIG. 6 is a schematic view of a gift card amount selection screen displayed by the gift coordinator during the operations of FIG. 2;

FIG. 7 is a schematic view of a accessory selection screen displayed by the gift coordinator during the operations of FIG. 2;

FIG. 8 is a flow diagram of additional gift coordination operations of the gift coordinator of FIG. 1;

FIG. 9 is a perspective view of the card organizer of FIG. 1 in a closed state;

FIG. 10 is a perspective view of the card organizer of FIG. 1 in an open state;

FIG. 11 is a rear view of the card organizer of FIG. 1;

FIG. 12 is a perspective view of a magnifier accessory to the card organizer of FIG. 1;

FIG. 13 is a perspective view of a note pad assembly accessory to the card organizer of FIG. 1;

FIG. 14 is a side view of the card organizer of FIG. 1 equipped with the magnifier of FIG. 12; and

FIG. 15 is a side view of the card organizer of FIG. 1 equipped with the note pad assembly of FIG. 13.

### DETAILED DESCRIPTION OF PREFERRED EMBODIMENTS

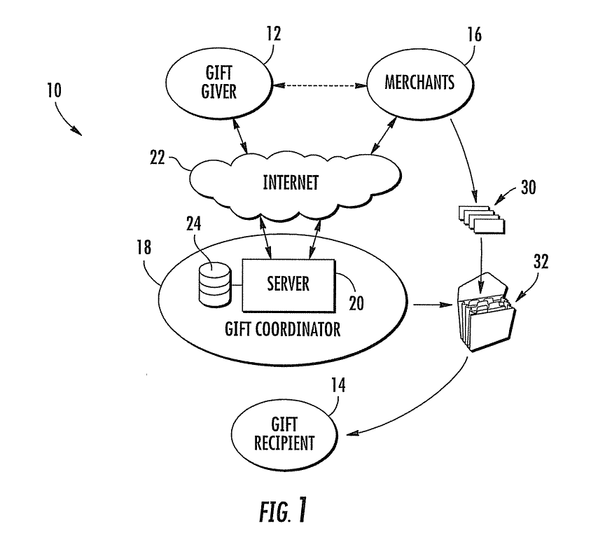

Referring to FIG. 1, a gift coordination system 10 includes at least one gift giver 12, at least one gift recipient 14, and a plurality of merchants 16. A gift coordinator 18 maintains a server 20 for facilitating communications with the gift giver 12 and the merchants 16. The server 20 communicates with the gift giver 12 and the merchants 16 through a communications medium such as the internet 22. The server 20 maintains a merchant database 24. The merchants 16 supply a plurality of gift cards 30 that are arranged in a card organizer 32 supplied by the gift coordinator 18. The gift cards 30 and card organizer 32 are received by the gift recipient 14.

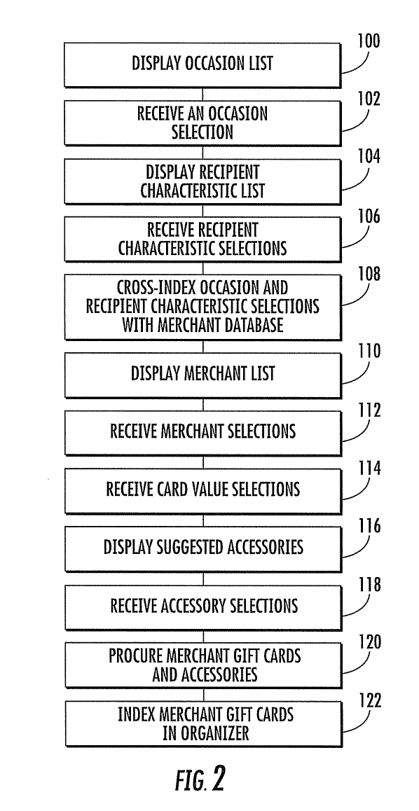

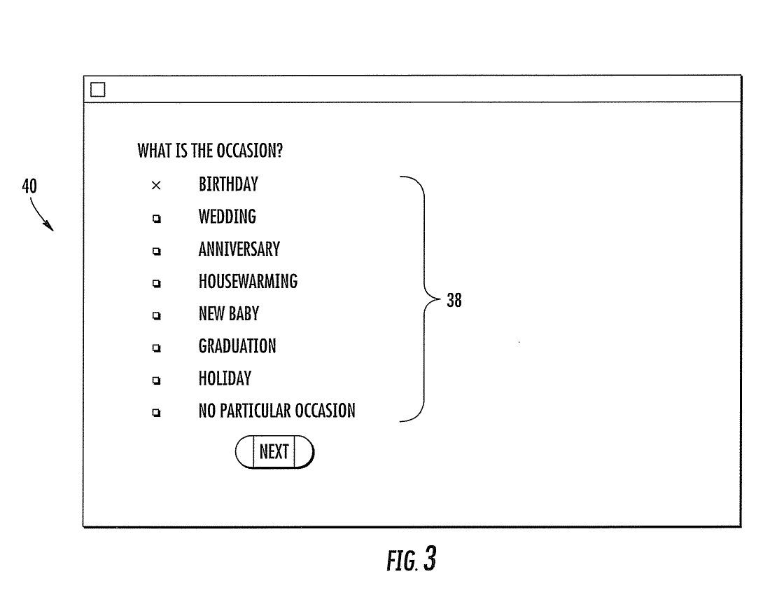

Referring to FIGS. 2-7, operations of the gift coordinator 18 in communication with the gift giver 12 will be explained. At block 100, the server 20 displays an occasion list 38, such as is displayed on screen 40 of FIG. 3. On screen 40, the gift giver 12 is prompted to select an occasion from the list 38 of gift giving occasions. Referring again to FIG. 2, at block 102 the server 20 receives the occasion selection made by the gift giver 12, such as the selection of “BIRTHDAY” in FIG. 3.

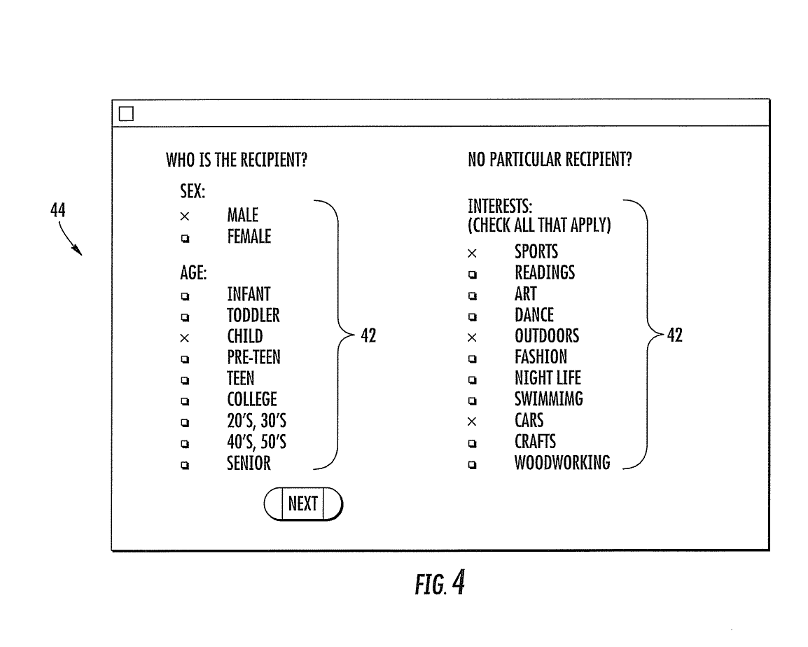

Referring to FIG. 4, after the occasion selection is received, the server 20 displays a recipient characteristic list 42 (at block 104 of FIG. 2). The gift giver 12 is prompted to select the characteristics that apply to the gift recipient 14. Referring again to FIG. 2, at block 106 the server 20 receives the recipient characteristic selections made by the gift giver 12, such as the selection of “MALE”, “CHILD”, “SPORTS”, “OUTDOORS” and “CARS” in FIG. 4.

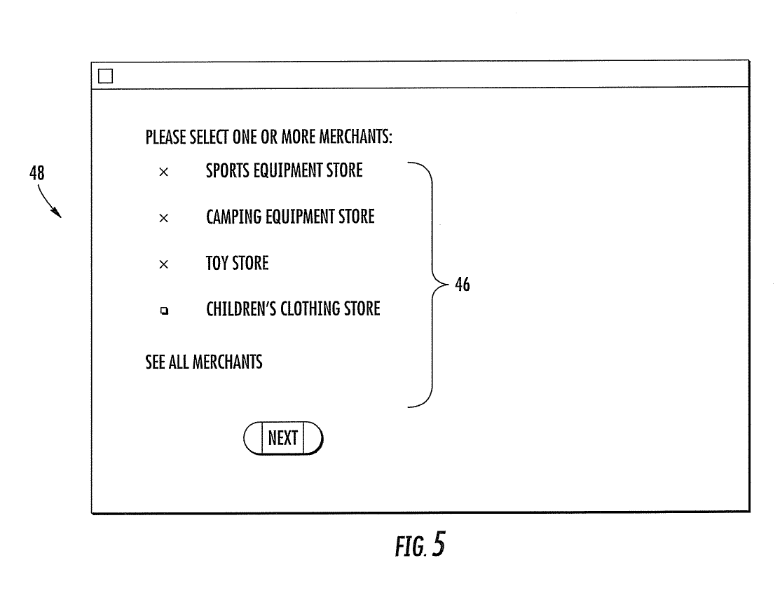

At block 108 of FIG. 2, the server 20 cross-indexes the occasion selections and recipient characteristic selections with the merchant database 24 to determine from which merchants 16 it would be most appropriate to purchase gift cards based on the selections received from the gift giver 12. A list 46 of merchants 16 identified at block 108 are displayed to the gift giver 12 at block 110, such as is displayed on screen 48 of FIG. 5. The gift giver 12 is prompted to select one or more of the merchants from the list 46 (at block 112 of FIG. 2), such as the selection of “SPORTS EQUIPMENT STORE”, “CAMPING EQUIPMENT STORE”, and “TOY STORE” in FIG. 5.

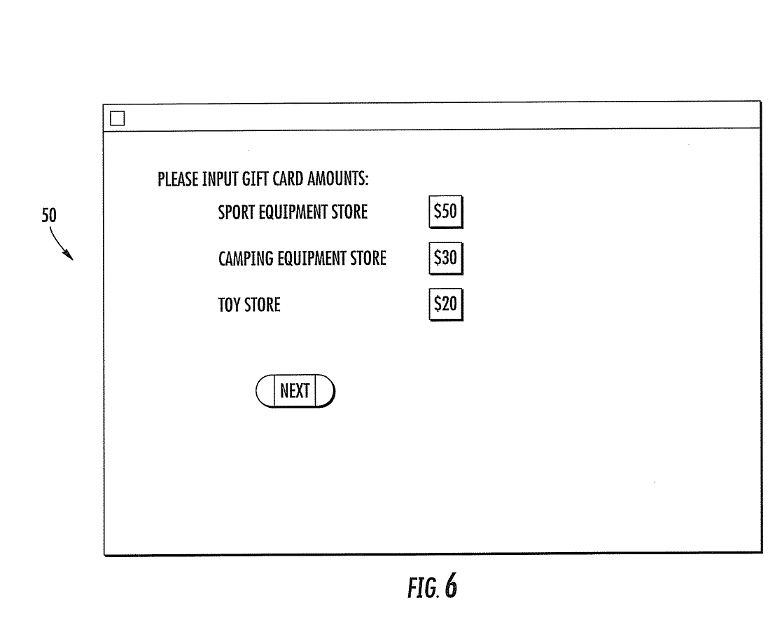

Referring again to FIG. 2, at block 114 gift card amounts are received from the gift giver 12, for gift cards 30 from each of the merchants selected at block 112. Referring to screen 50 of FIG. 6, gift card amounts inputted include, for example, “$50” from the “SPORTS EQUIPMENT STORE”, “$30” from the “CAMPING EQUIPMENT STORE”, and “$20” from the “TOY STORE”.

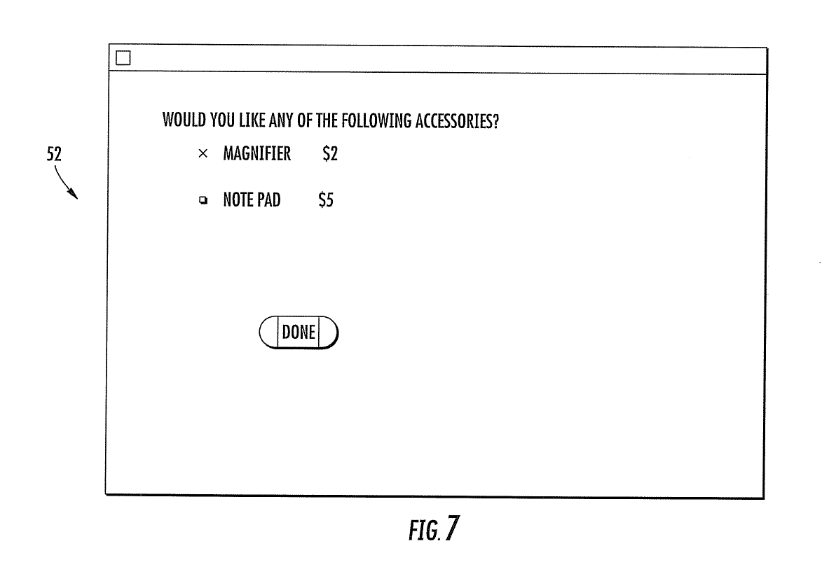

Referring again to FIG. 2, at block 116 the server 20 suggests accessories to accompany the gift cards 30, such as the “MAGNIFIER” and “NOTE PAD” listed on screen 52 of FIG. 7. The gift giver 12 is prompted to select any desired accessories, and the input is received by the server (at block 118 of FIG. 2). On screen 52 of FIG. 7, the “MAGNIFIER” accessory has been selected.

Once the selections have been made, an on-line checkout can occur as known, where payment is received for the gift cards 30 and any accessories selected (examples of accessories are described in detail below in connection with the card organizer 32), together with any additional charges, for example for taxes, shipping, and for the card organizer 32. Additionally, further selections can be received for different colors or designs of the card organizer 32.

Referring again to FIG. 2, at block 120 the gift cards 30 and accessories are procured and, at block 122, indexed within the card organizer 32. The card organizer 32 is then ready for giving to the gift recipient 14. In one embodiment of the invention, the gift coordinator 18 obtains the gift cards 30 from the merchants 16 and indexes them in the card organizer 32, which is given to the gift recipient 14, or to the gift giver 12 for presenting to the gift recipient 14. In another embodiment of the invention, the gift coordinator 18 suggests the merchants 16 from which gift cards 30 should be obtained, and supplies the card organizer 32 and any accessories, while the gift giver 12 obtains the gift cards 30 directly from the merchants 16. In this other embodiment, it is not necessary to receive the card value selections of block 114, as the gift giver will not be purchasing the gift cards 30 through the gift coordinator 18.

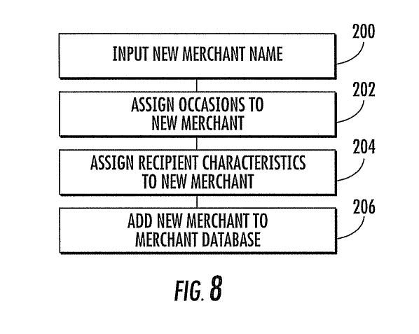

Referring to FIG. 8, operations of the gift coordinator 18 to enter a new merchant 16 into the merchant database 24 will be explained. At block 200, the name of the merchant 16 is inputted. To help future gift givers 12 to recognize the merchant 16, a trademark or logo can also be inputted, which can then be displayed next to the corresponding merchant 16 in the list 46. At block 202, occasions are assigned to the merchant 16. For example, “HOUSEWARMING” could be assigned to a merchant 16 that is a home improvement or home decor store. Accordingly, such a merchant 16 will then appear in the list 46 when “HOUSEWARMING” is selected as the gift giving occasion.

At block 204, recipient characteristics are assigned to the merchant 16. For example, “MALE” could be assigned to a men's clothing store and “SPORTS” could be assigned to a sporting goods store. As with the occasion assignments of block 202, the recipient characteristic assignments will cause the merchant 16 to appear in the list 46 when the assigned recipient characteristics are selected by a gift giver 12. Once the actions of blocks 202 and 204 have been taken, the new merchant 16 is added to the merchant database 24 at block 206.

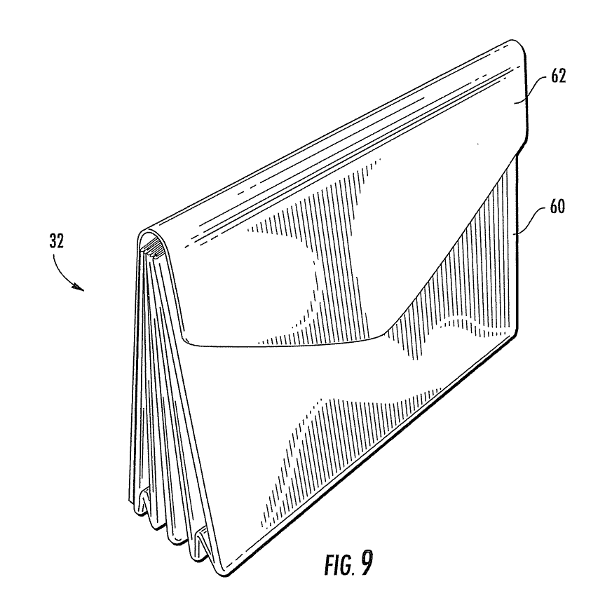

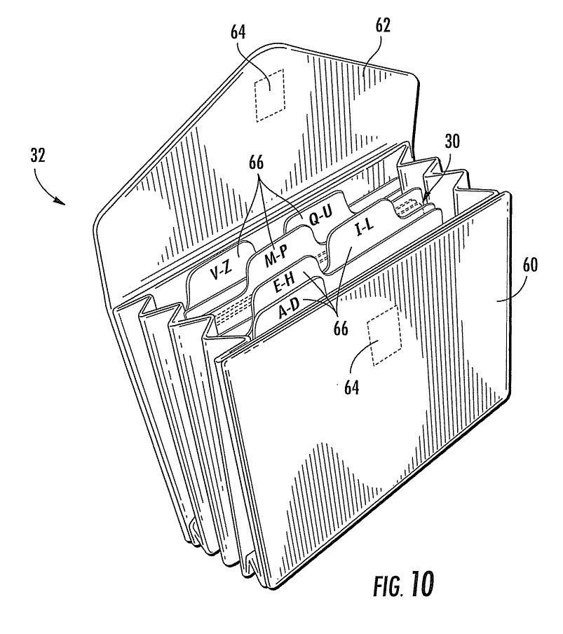

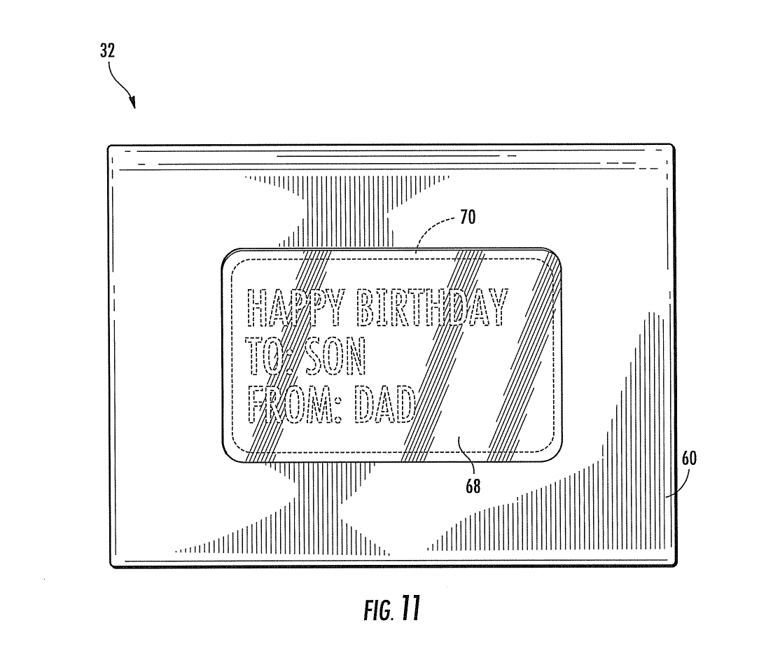

Referring to FIGS. 9-11, the structure of the card organizer n will be explained. The card organizer 32 includes an expandable pouch 60 that is selectively closable by an integral flap 62 using fastening elements 64. The pouch 60 is preferably dimensioned to be readily accommodated in a purse or a large garment pocket, and to accommodate a plurality of credit card-sized gift cards 30 one behind another. Suitable materials for the pouch 60 include real and artificial leathers. The fastening elements 62 include, for example, hook and loop fastener elements.

A plurality of tabbed dividers 66 are arranged within the pouch 60, such that gift cards 30 can be inserted therebetween. The dividers 66 include indexing indicia, for example letters of the alphabet, such that the gift cards can be associated with the appropriate divider in the pouch. Instead of, or in addition to, letters of the alphabet, other indexing indicia can also be employed. For example, dividers 66 including merchant type or card expiration date indicia can also be arranged within the pouch 60. The dividers can be integral with, connected to, or separate from the pouch 60. Additionally, other items, such as coupons, notes, and business cards can be stored within the pouch 60.

A side of the pouch 60 includes a transparent window 68, through which information may be read. For instance, the identity of the gift giver 12 or gift recipient 14 can be printed on a card 70 located behind the window 68, for instance on a business card. Also, a message to the gift recipient 14 from the gift giver 12 could be located behind the window 68. In one aspect of the invention, the message to be printed on the card 70 is inputted into the server 20 by the gift giver 12, such that the card organizer 32 is delivered to the gift recipient 14, or gift giver 12 for presentation to the recipient 12, with the card 70 already in place.

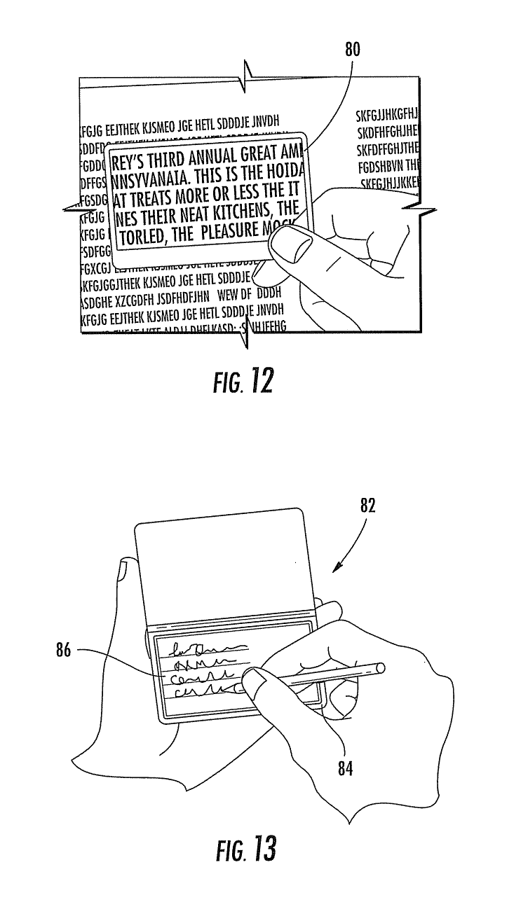

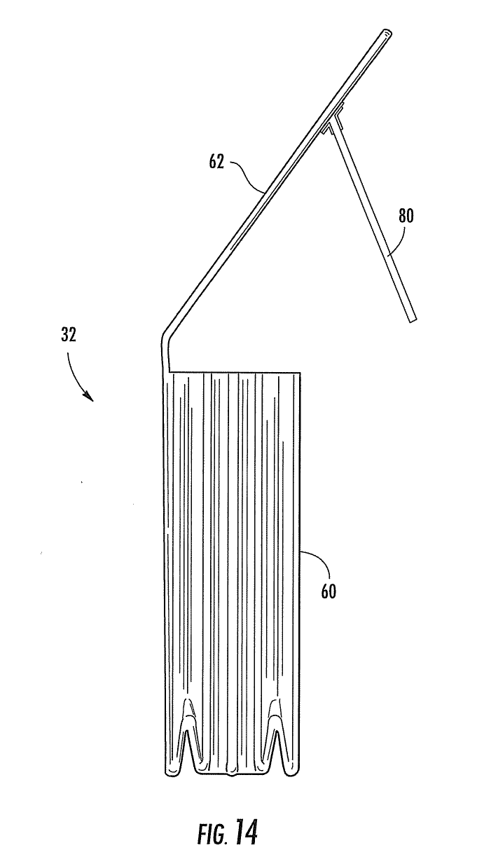

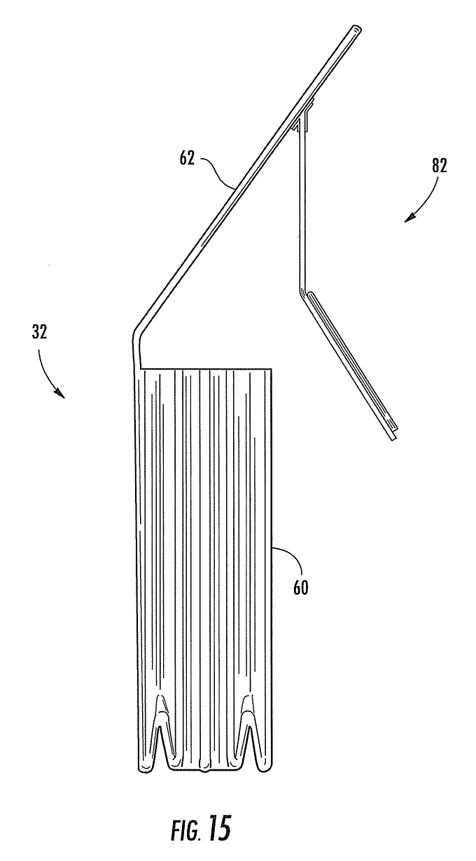

Referring to FIGS. 12 and 13, possible accessories for the card organizer 32 include a magnifier 80 and a note pad assembly 82, including a small pen 84 and note pad 86. Both the magnifier 80 and note pad assembly 82 are preferably dimensioned to be approximately the same size as a gift card, so as to be readily accommodated within the card organizer 32. The magnifier 80 and note pad assembly 82 could also include tabs to help them be easily located within the pouch 60. Alternately, the magnifier 80 or note pad assembly 82 can be attached to the flap 62 of the pouch 60, as shown in FIGS. 14 and 15.

The present invention is not limited to the embodiments herein shown and described. Instead, those skilled in the art will appreciate that various modifications, and adaptations to particular circumstances, are all possible within the scope of the present invention.

What is claimed is:

1. A gift card organization system comprising:
an expandable pouch including a pouch body defining an interior volume and at least one opening communicating therewith;
a plurality of dividers arranged within the interior volume and including gift card indexing indicia thereon; and
a plurality of gift cards arranged within the interior volume and sorted between the plurality of dividers based on the gift car indexing indicia.

2. The system of claim 1, further comprising an identity card having identifying information thereon;
wherein the expandable pouch includes a substantially transparent window on a side thereof, the identity card being arranged behind the window such that the identifying information is visible from the outside of the expandable pouch.

3. The system of claim 1, wherein the expandable pouch further includes a flap for selectively covering the at least one opening.

4. The system of claim 3, wherein the expandable pouch further includes complementary fastening elements for releasably securing the flap in position covering the at least one opening.

5. The system of claim 1, wherein the gift card indexing indicia include at least one of: letters of the alphabet, gift card expiration date indicia and merchant type indicia.

6. The system of claim 5, wherein the gift card indexing indicia includes letters of the alphabet.

7. The system of claim 1, further comprising a magnifier associated with the pouch, the magnifier having dimensions approximately equal to a gift card.

8. The system of claim 7, wherein the magnifier is arranged within the interior volume of the pouch.

9. The system of claim 8, wherein the magnifier is tabbed to facilitate location of the magnifier within the pouch.

10. The system of claim 7, wherein the expandable pouch further includes a flap for selectively covering the at least one opening and the magnifier is connected to the flap.

11. The system of claim 1, further comprising a note pad assembly associated with the pouch, the note pad assembly having dimensions approximately equal to a gift card.

12. The system of claim 11, wherein the note pad assembly is arranged within the interior volume of the pouch.

13. The system of claim 12, wherein the note pad assembly is tabbed to facilitate location of the note pad within the pouch.

14. The system of claim 11, wherein the expandable pouch further includes a flap for selectively covering the at least one opening and the note pad assembly is connected to the flap.

15. The system of claim 1, further comprising a server for generating gift card recommendations for selecting the gift cards in the interior volume of the pouch based on at least one of: characteristics of a gift recipient and a gift occasion.

16. A method for organizing gift cards, the method including:
arranging a plurality of dividers within an expandable pouch, the plurality of dividers having indexing indicia for the plurality of gift cards thereon;
selecting a plurality of gift cards for insertion into the expandable pouch;
sorting the plurality of gift cards based on the indexing indicia; and
inserting the plurality of gift cards into the expandable pouch such that the plurality of gift cards correspond with the plurality of dividers having associated indexing indicia.

17. The method of claim 16, wherein the indexing indicia include at least one of: letters of the alphabet, gift card expiration date indicia and merchant type indicia.

18. The method of claim 16, wherein selecting the plurality of gift cards includes selecting the plurality of gift cards from among a plurality of merchants based on at least one of: characteristics of a gift recipient and a gift occasion.

19. The method of claim 18, wherein selecting the plurality of gift cards from among a plurality of merchants includes accessing a server having a database of the plurality of merchants cross-indexed with gift recipient characteristics and gift occasions.

20. A gift coordination system comprising:
a gift coordinator including a server accessible by at least one gift giver, the server including a merchant database of merchants for supplying gift cards, the merchant database being cross-indexed with gift recipient characteristics and gift occasions, the server adapted to recommend merchants for supplying gift cards based on at least one of the gift recipient characteristics and gift occasions; and
a card organizer including an expandable pouch with a plurality of dividers arranged therein and having gift card indexing indicia thereon.
